(19) United States
(12) Patent Application Publication
(10) Pub. No.: US 2009/0075145 A1
(43) Pub. Date: Mar. 19, 2009

(54) SOLID OXIDE TYPE FUEL CELL

(75) Inventors: Fumimasa Katagiri, Nagano-shi (JP); Yasue Tokutake, Nagano-shi (JP); Michio Horiuchi, Nagano-shi (JP); Shigeaki Suganuma, Nagano-shi (JP); Jun Yoshiike, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-shi (JP)

(21) Appl. No.: 12/201,368

(22) Filed: Aug. 29, 2008

(30) Foreign Application Priority Data
Aug. 30, 2007 (JP) 2007-224519

(51) Int. Cl. H01M 8/10; H01M 4/86

(52) U.S. Cl. 429/31; 429/40

(57) ABSTRACT

The solid oxide type fuel cell includes a cylindrical-shaped member S which includes an anode A on the inner surface of a cylindrical-shaped electrolyte E made of a solid oxide and a cathode on the outer surface thereof. The anode A contains an oxidation catalyst at least on the surface thereof. A fuel gas F is supplied from one end of the cylindrical-shaped member S, and a discharge gas, which is discharged from the other end of the cylindrical-shaped member S and includes uncombusted and/or incompletely combusted components, is combusted using flame combustion outside the cylindrical-shaped member S. Owing to the increased temperature of the cylindrical-shaped member S caused by the flame combustion B, the fuel gas F is combusted using catalyst combustion F within the cylindrical-shaped member S, thereby generating power.

### BACKGROUND OF THE INVENTION

The present invention relates to a solid oxide type fuel cell using catalyst combustion.

A solid oxide type fuel cell including an electrolyte made of a solid oxide is capable of raising its operating temperature and thus can avoid the need of use of a catalyst for promoting the action of the fuel cell; and, therefore, the solid oxide type fuel cell has an advantage that it can reduce its running cost. However, in order to prevent environmental pollution and health damage caused by uncombusted carbon and hydrocarbon as well as incompletely combusted components such as CO and NOx which are contained in a discharge gas, it is necessary to carry out a discharge gas purifying operation which reduces the discharge amounts of these components to the outside as much as possible.

For example, in the patent reference 1 and 2, there is disclosed a solid oxide type fuel cell which includes a cylindrical-shaped member including an anode on the inner surface of a cylindrical-shaped electrolyte made of a solid oxide and a cathode on the outer surface of the electrolyte, and also in which a fuel is combusted using flame combustion within the cylindrical-shaped member to thereby generate electricity. According to this fuel cell, in the flame reducing area thereof just adjacent to the inner wall of the cylindrical-shaped member with which the flame is contacted, inevitably, there occurs un-combustion or incomplete combustion.

Also, in the patent reference 3, there is disclosed a method in which the un-combusted components of a combusted and discharged gas are used as the fuel of a solid oxide fuel cell and the energy of the discharged gas is collected and used in peripheral equipment. However, this method cannot purify the discharged gas of the solid oxide type fuel cell.

| | |
|---|---|
| [Patent Reference 1] | JP-A-2006-179291 |
| [Patent Reference 2] | JP-A-2006-179295 |
| [Patent Reference 3] | JP-A-Hei-05-060310 |

### SUMMARY OF THE INVENTION

In view of the above, it is an object of the present invention to provide a solid oxide type fuel cell having a discharge gas purifying function which can reduce greatly the discharge of uncombusted and/or incompletely combusted components of a discharge gas to the outside.

In attaining the above object, according to a first aspect of the invention, there is provided a solid oxide type fuel cell including a cylindrical-shaped member,

the cylindrical-shaped member including:

a cylindrical-shaped electrolyte made of a solid oxide,

an anode formed on an inner surface of the cylindrical-shaped electrolyte, and

a cathode formed on an outer surface of the cylindrical-shaped electrolyte, wherein

the anode includes an oxidation catalyst at least on the surface thereof,

a fuel gas is supplied from one end of the cylindrical-shaped member,

a discharge gas discharged from the other end of the cylindrical-shaped member and including uncombusted and/or incompletely combusted components is combusted using flame combustion outside the cylindrical-shaped member, and

the fuel gas is combusted using catalyst combustion within the cylindrical-shaped member owing to the raised temperature of the cylindrical-shaped member caused by the flame combustion to generate power.

According to a second aspect of the invention, there is provided the solid oxide type fuel cell as set forth in the first aspect, constituting a burner nozzle for combustion equipment.

According to the solid oxide type fuel cell of the invention, since the discharge gas is combusted using flame combustion outside the cylindrical-shaped member constituting the main body of the fuel cell, the flame is prevented from touching the cylindrical-shaped member and no inflammation area is thereby generated. Therefore, the discharge gas can be easily combusted completely, thereby being able to reduce greatly the discharge of the uncombusted and/or incompletely combusted components of the discharge gas to the outside.

### BRIEF DESCRIPTION OF THE DRAWINGS

FIG. 1 (1) is a perspective view of a solid oxide type fuel cell according to the invention; FIG. 1 (2) is a perspective view of the main body of the fuel cell; and, FIG. 1 (3) is a transverse section view of the cell main body.

FIG. 2 is a graphical representation of the power generating characteristic of the solid oxide type fuel cell according to the invention.

FIG. 3 is a perspective view of the solid oxide type fuel cell according to the invention, showing a state where it is generating power with the periphery thereof surrounded by a heat insulating material.

FIG. 4 is a graphical representation of the power generating characteristic of the solid oxide type fuel cell according to the invention provided when the periphery of the fuel cell is surrounded by a heat insulating material.

FIG. 5 is a perspective view of a plurality of solid oxide type fuel cells according to the invention bundled together, showing a state where they are generating power with the periphery of the bundle surrounded by a heat insulating material.

### DETAILED DESCRIPTION OF THE PREFERRED EMBODIMENTS

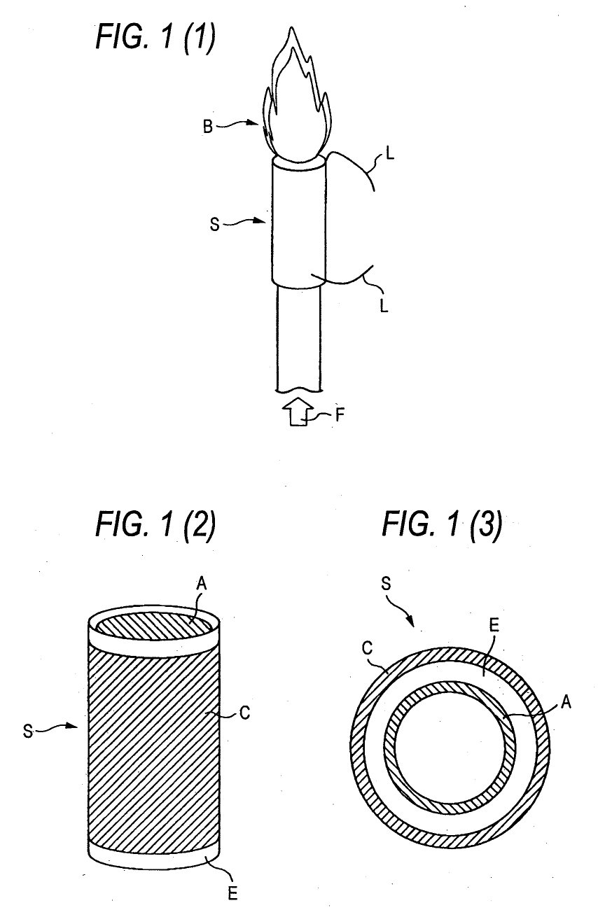

FIGS. 1(1) to 1(3) typically show the basic structure of a solid oxide type fuel cell according to the invention.

A solid oxide type fuel cell S according to the invention includes a cylindrical-shaped member which includes an anode A on the inner surface of a cylindrical-shaped electrolyte E made of a solid oxide and a cathode on the outer surface thereof. The anode A contains an oxidation catalyst at least on the surface thereof. As the oxidation catalyst, preferably, there may be used a metal belonging to a platinum group (precious metals) such as Pt, Pd or Rh which is resistant against heat. Also, the anode A and cathode C respectively include meshes (not shown) each made of Pt or the like as a collector and, from the respective collectors, there are extended lead wires L made of Pt or the like to the outside as output terminals.

As the cylindrical-shaped electrolyte E made of a solid oxide, there can be used a known solid electrolyte which is used in a fuel cell and, for example, there are available the following materials.

(a) Zirconia-system ceramics such as YSZ (yttria stabilized zirconia), ScSZ (Scandia stabilized zirconia), and Ce doped YSZ or ScSZ, and Al doped YSZ or ScSZ.
(b) Cerium-system ceramics such as SDC (samarium doped cerium) and GDC (gadolinium doped cerium).
(c) LSGM (lanthanum gallate)
(d) Bismuth-oxide-system ceramics

Also, as materials for forming the anode A, there can be used known materials, for example, there can be used the following materials.

(a) Cermet including nickel and yttria stabilized zirconia-system ceramic, or Scandia stabilized zirconia-system ceramic, or cerium-system (SDC, GDC, YDC or the like) ceramic.
(b) Cermet including nickel, cobalt and yttria stabilized zirconia-system ceramic, or Scandia stabilized zirconia-system ceramic, or cerium-system ceramic.
(c) Sintered material mainly made of a conductive oxide (50% or more by weight to 99% or less by weight) such as nickel oxide including solution treated lithium.
(d) Materials produced by blending a metal made of a platinum-group element or an oxide thereof about 1˜10% by weight with the materials stated in the above-mentioned items (a), (b) and (c).

Of the above materials, (a), (b) and (c) are particularly preferable.

The sintered material mainly made of a conductive oxide stated in the (c) has an excellent oxidation resistance and, therefore, it can prevent the occurrence of phenomena caused by the oxidation of the anode layer, for example, the lowered power generating efficiency due to the increased electrode resistance of the anode layer, a power generation failure, and the detachment of the anode layer from the solid electrolyte layer. Also, as the conductive oxide, preferably, there may be used the above-mentioned nickel oxide including solution treated lithium. Further, when there are used materials which are obtained by blending a metal made of a platinum-group element or the oxide thereof into the materials stated in the above articles (a), (b) and (c), there can be provided a high power generating performance.

And, as the material of the cathode C as well, there can be used known materials, for example, a manganese compound made of elements of the third group of the periodic table such as lanthanum or samarium with strontium (Sr) added thereto (for example, lanthanum strontium manganite), a gallium oxide compound, or a cobalt oxide compound (for example, a lanthanum strontium cobaltite, or a samarium strontium cobaltite), or a ferrite-system compound (for example, a lanthanum strontium cobalt ferrite).

Further, when a carbon-system pore-forming material is added to the cathode C as the need arises, there can be provided a higher power generating performance.

A fuel gas F is supplied from one end of the cylindrical-shaped member S and a discharge gas, which is discharged from the other end of the member S and contains an uncombusted component and/or an incompletely combusted component, is combusted using flame combustion B outside the cylindrical-shaped member B. Even if the fuel gas F is supplied, the cell S is not operated. When the fuel gas F discharged uncombusted before the time of the operation of the cell S is ignited, the flame combustion B starts. When the cylindrical-shaped member S is raised in temperature due to this flame combustion B and the temperature of the member S reaches a catalyst combustion temperature, the catalyst combustion of the fuel gas within the cylindrical-shaped member S starts, whereby the operation of the fuel cell is started. Here, the catalyst combustion, generally, can occur at the temperatures of 200˜300° C.

The fuel gas F supplied from one end of the cylindrical-shaped member S, after it participates in the power generating reaction of the fuel cell within the cylindrical-shaped member S, is discharged from the other end of the cylindrical-shaped member S and is combusted completely using the flame combustion B, whereby there is left no uncombusted component or incompletely combusted component.

A solid oxide type fuel cell according to the invention, typically, can be used as a burner nozzle for combustion equipment. Power generated in this manner, in a basic embodiment, can be used as an operating power for the combustion equipment itself. Specifically, the power can be used in a gas fan heater together with a condenser, that is, it can be used as a power to start combustion, to drive a fan, and to display a display panel.

### Embodiment 1

A solid oxide type fuel cell according to the invention shown in FIG. 1 is manufactured according to the following procedures.

As the solid electrolyte E, a green sheet of Smo.2Ceo.8O1.9 (samarium doped cerium: SDC) formed according to a doctor blade method is formed in a cylindrical shape, a paste made of nickel, cobalt and SDC is printed on the inner surface of the cylindrical-shaped member as the anode A, a paste of Smo.5Sro.5CoO3 and SDC is printed on the outer surface thereof as the cathode C, and the cylindrical-shaped member is burned at the temperature of 1200° C., thereby producing a cylindrical-shaped cell. The cylindrical-shaped cell had the following dimensions, that is, a height of 17 mm and an inside diameter of 4.0 mm ø.

Next, as the collector, platinum meshes are attached to the two electrodes of the anode A and cathode C with their respective electrode pastes, and the cylindrical-shaped cell is burned again at the temperature of 1200° C. to thereby fix the collector to the cylindrical-shaped cell.

Finally, in order to allow use of catalyst combustion, a hexachloroplatinate acid, which is a solution containing platinum, is permeated onto the surface of the anode A and is dried at the temperature of 70°, thereby completing the solid oxide type fuel cell S.

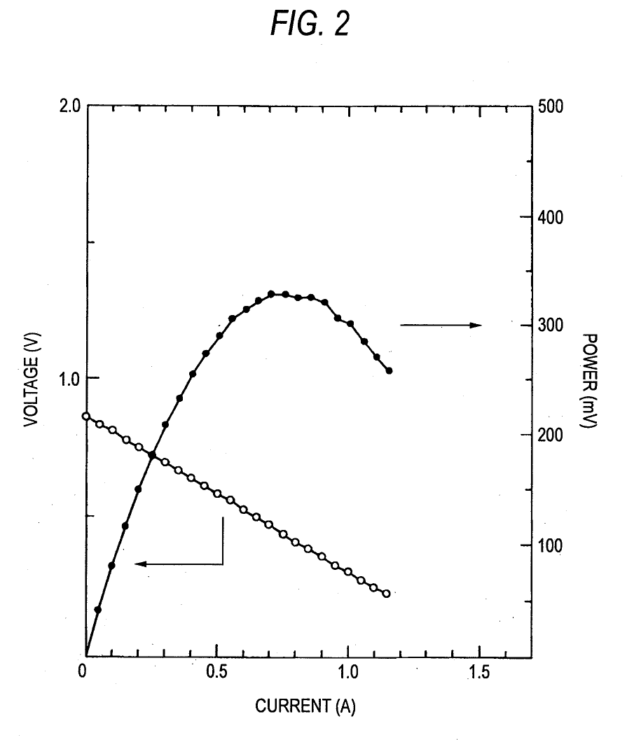

The thus produced solid oxide type fuel cell S is measured for the power generating performance thereof using a mixed gas of the air—10% of butane as the fuel gas F with a total flow amount of 900 sccm. As a result of this, as shown in FIG. 2, a power of 330 mW could be generated.

### Embodiment 2

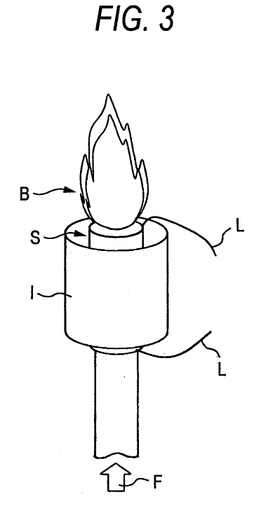

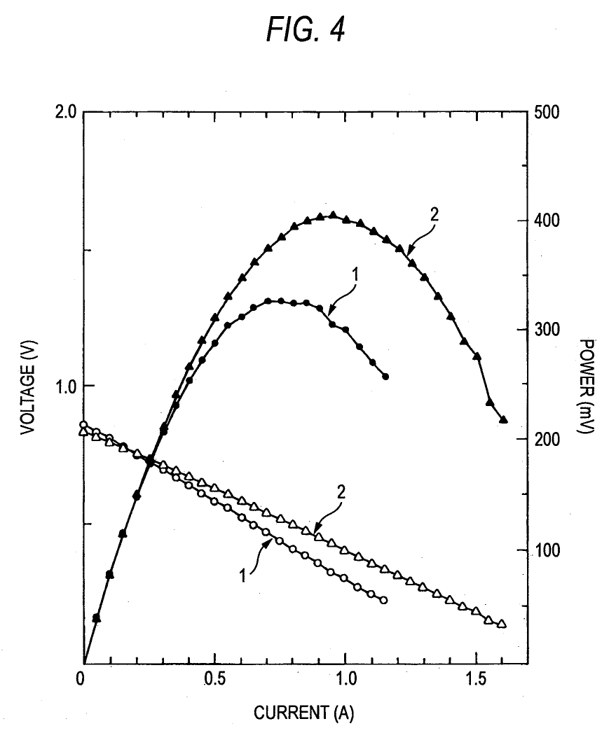

As shown in FIG. 3, in a state where the periphery of the solid oxide type fuel cell S according to the embodiment 1 is surrounded by a cylindrical-shaped heat insulating material I (material: alumina), the solid oxide type fuel cell S is measured for the power generating performance thereof under the same combustion supply condition as in the embodiment 1, thereby checking the fuel cell S for its heat retaining effect. As a result of this, as shown by a curved line 2 in FIG. 4, a power of 400 mW could be generated and, when compared with the result obtained by the embodiment 1 without using the heat insulating material I (the curved line 1 shown in FIG. 4), it is confirmed that the output of the fuel cell S according to the present embodiment increased by 70 mW.

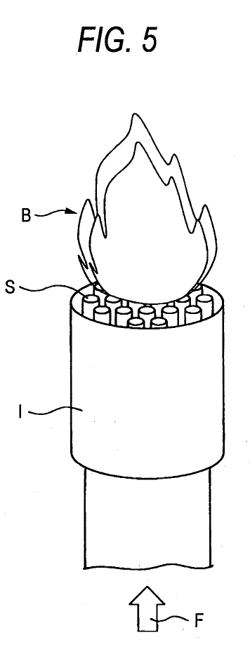

Here, in the embodiment 2, although the periphery of a single fuel cell S is surrounded by the heat insulating material I for heat retention, alternatively, as shown in FIG. 5, a plurality of fuel cells S can be bundled together and the periphery of the fuel cells S can be surrounded with the heat insulating material I. In this case, since the thus bundled fuel cells S cooperate together in retaining heat between mutually adjoining ones, it can be expected that the power generating efficiency can be enhanced further.

### Embodiment 3

Next, using the solid oxide type fuel cell S according to the embodiment 1, the following two cases are compared with each other as to the discharge amounts of CO at the time of power generation: that is, one case where the fuel component when it is discharged is combusted using flame combustion; and, the other where the fuel component is combusted without using flame combustion. According to this comparison, in the case using the flame combustion, the density of CO in the discharged gas is almost 0 ppm, whereas, in the case using no flame combustion, the CO density is high, that is, 1000 ppm. This shows that, although the discharge gas contains a large amount of CO produced due to the modified quality of the fuel, use of the flame combustion makes it possible to completely combust most of the CO component of the discharge gas.

According to the invention, there can be provided a solid oxide type fuel cell having a discharge gas purifying function which can greatly reduce the discharge of the uncombusted and/or incompletely combusted components of a discharge gas to the outside.

What is claimed is:

1. A solid oxide type fuel cell comprising a cylindrical-shaped member,
the cylindrical-shaped member comprising:
a cylindrical-shaped electrolyte made of a solid oxide,
an anode formed on an inner surface of the cylindrical-shaped electrolyte, and
a cathode formed on an outer surface of the cylindrical-shaped electrolyte, wherein
the anode includes an oxidation catalyst at least on the surface thereof,
a fuel gas is supplied from one end of the cylindrical-shaped member,
a discharge gas discharged from the other end of the cylindrical-shaped member and including uncombusted and/or incompletely combusted components is combusted using flame combustion outside the cylindrical-shaped member, and
the fuel gas is combusted using catalyst combustion within the cylindrical-shaped member owing to the raised temperature of the cylindrical-shaped member caused by the flame combustion to generate power.

2. The solid oxide type fuel cell as set forth in claim 1, constituting a burner nozzle for combustion equipment.
